(19) United States
(12) Patent Application Publication
(10) Pub. No.: US 2001/0028928 A1
(43) Pub. Date: Oct. 11, 2001

(54) Skein label

(75) Inventors: Philippe Thomas Derevoge, Avon (FR); Jean-Paul Ganaye, Sausheym (FR)

Correspondence Address: Morris Liss, Pollock, Vande, Sande & Priddy, R.L.L.P., P.O. Box 19088, Washington, DC, 20036-3425, US

(73) Assignee: Dollfus & Mieg Cie - DMC, Paris (FR)

(21) Appl. No.: 09/825,945

(22) Filed: Apr. 5, 2001

(30) Foreign Application Priority Data
Apr. 5, 2000 (FR) 00 04352

(51) Int. Cl. B32B 1/08; B65D 3/28; B29D 23/00; G09F 3/02

(52) U.S. Cl. 428/34.2; 40/628

(57) ABSTRACT

Label intended to go around a skein of yarns or the like, which comprises a projecting part extended by a tab which can be folded down inside a loop of the said skein so as to neatly separate of the said yarns by creating the said loop in a permanent way, and to limit any relative slip of the label with respect to the said skein

The present invention relates to a label intended for an assembly of yarns folded over themselves in several turns (hereafter, called a “skein”) and allowing the said yarns to be neatly separated by creating a loop made in the skein (small hank).

According to another aspect of the invention, it relates to a device for supporting the skein provided with this label, saving time and allowing the user to handle it more easily.

Wool yarns, silk yarns, cotton yarns, etc. are generally presented either in the form of a skein held in position by means of two labels going around the latter in its upper and lower parts, or in the form of reels or balls. Presentation in the form of skeins allows the product to be easily handled and transported.

When using this product, the consumer is required either to remove the labels from the skein before winding it up on a support of the type comprising a piece of cardboard or the like, before being able to start to work, or to pull the necessary yarn while ensuring that the coils as they are do not drop. It will be easily understood that the latter step is irksome.

Moreover, after the labels have been removed from the skein, the yarns which are no longer held in place by the latter tend to entangle, which does not facilitate the user's task.

Finally, once the yarn has been wound onto its work support, it is necessary to copy down the color number of the yarn, which number is generally written on one of the labels for holding the skein in place, without which, when the shades of color are highly varied, the user can no longer identify the colors that he has to use.

The present invention therefore aims to alleviate such drawbacks by providing a label with a tab for holding the skein in place, which allows neat separation of the yarns by creating in a definitive manner a loop made in the skein.

For this purpose, the label intended to go around a skein of yarns or the like according to the invention is characterized in that it comprises a projecting part extended by a tab which can be folded down inside a loop of the said skein so as to neatly separate the said yarns by creating the said loop in a permanent way, and to limit any relative slip of the label with respect to the said skein.

Further features and advantages of the present invention will become apparent from the description given below, with reference to the appended drawings which illustrate one embodiment thereof which is devoid of any limiting character. In the figures:

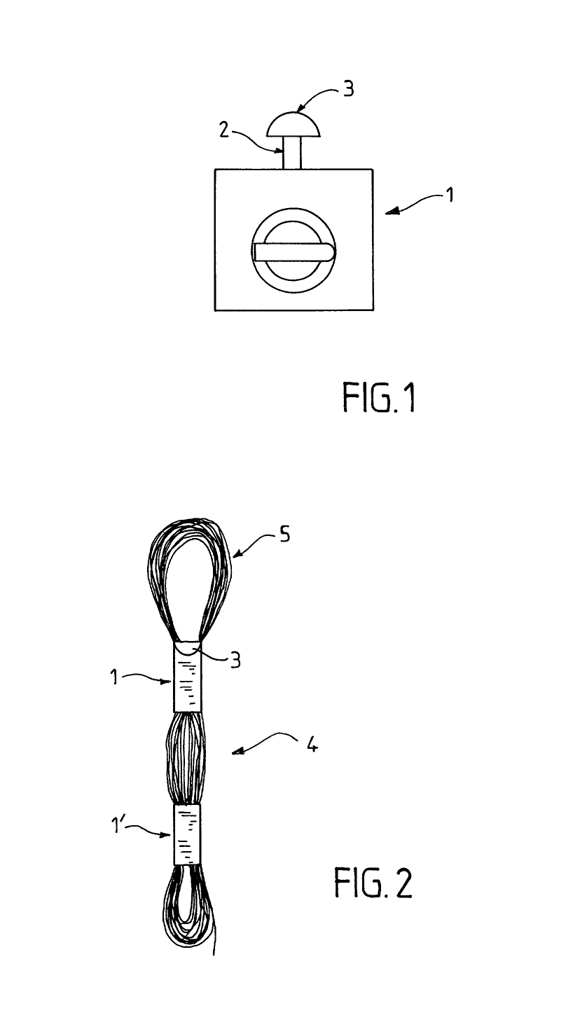

FIG. 1 shows a plan view of the label according to the invention; and

FIG. 2 is a plan view of a skein combined with the label according to the invention.

FIG. 1 shows that the label 1 according to the invention is preferably of square or rectangular shape and has a projecting part 2 extended by a tab 3 in the form of, for example, a mushroom (or half-moon). This label is intended to go around an assembly 4 of yarns folded on themselves in several turns (“skein” or small hank) and is held in this position by any adhesive bonding means. Of course, two labels 1 and 1′ may be used in order to hold the said skein in place, it being possible for one or both of them to be labels according to the invention.

Once the label has been mounted on the skein 4 (cf. FIG. 2), the tab 3 extending the projecting part 2 of the latter is folded down inside one of the loops 5 formed at the two ends of the said skein so as to neatly separate, in a permanent way, the yarns within this loop. The said tab separates the two sides of the said loop formed by the yarns above the label and therefore makes it easier for the skein to be used.

Furthermore, the presence of the tab 3 prevents any unintentional relative slip of the label 1 with respect to the skein 4, which would consequently disorganize the assembly of yarns in the skein and possibly result in the loss of the latter.

1. Label intended to go around a skein of yarns or the like, which comprises a projecting part extended by a tab which can be folded down inside a loop of the said skein so as to neatly separate of the said yarns by creating the said loop in a permanent way, and to limit any relative slip of the label with respect to the said skein.

2. Skein of yarns or the like, which is held in place by at least one label according to claim 1.
